(19) United States
(12) Patent Application Publication
(10) Pub. No.: US 2010/0224432 A1
(43) Pub. Date: Sep. 9, 2010

(54) MOTORCYCLE

(76) Inventors: Yong Bum Kwon, Daegu (KR); Hyun Sik Jang, Gumi-si (KR)

Correspondence Address: KED & ASSOCIATES, LLP, P.O. Box 221200, Chantilly, VA, 20153-1200, US

(21) Appl. No.: 12/681,983

(22) PCT Filed: Oct. 10, 2008
(86) PCT No.: PCT/KR08/05959

§ 371 Date: Apr. 7, 2010

(30) Foreign Application Priority Data
Oct. 11, 2007 (KR) 10-2007-0102459

(51) Int. Cl. B62K 11/00; B62M 7/00; B60K 7/00

(52) U.S. Cl. 180/252; 180/55

(57) ABSTRACT

A motorcycle has at least two independently driven wheels to reduce energy consumption. The independently driven wheels are driven independently.

### TECHNICAL FIELD

Disclosed herein is a motorcycle having at least two independently driven wheels to reduce energy consumption.

### BACKGROUND ART

Generally, a motorcycle is a widely used due to low price, small size and low energy consumption.

A motorcycle has a small and lightweight body as compared to a car, so the amount of energy required for driving is greatly lower than that of a car. However, due to recent sudden rise of oil price, the burden caused by even such a small amount of energy is increasing. Also, with a view to preventing environmental pollution caused by fossil fuel usage, an electric motorcycle is developed.

However, the electric motorcycle can travel only dozens of kilometers after one-time filling, so its practicality is not ensured. Thus, there is a strong need to ensure a sufficient travel distance with one-time filling by greatly decreasing the amount of energy consumed during driving.

### DISCLOSURE OF INVENTION

### Technical Problem

In order to solve the above problems, there is provided a motorcycle that greatly reduces energy consumption by having at least two independently driven wheels, thereby maximizing energy efficiency.

### Technical Solution

In an aspect, there is provided a low energy consumption motorcycle, which has at least two independently driven wheels that are driven independently.

Here, each independently driven wheel may be driven using a motor, thereby not causing environmental problems.

In particular, the independently driven wheel may be a motor built-in wheel that has a built-in motor in a wheel, thereby occupying no additional space for the motor and eliminating energy loss occurring in the power transmission process.

Meanwhile, in the low energy consumption motorcycle, at least one of the independently driven wheels may be arranged at a front portion of the motorcycle, and at least one of the independently driven wheels may be arranged at a rear portion of the motorcycle. In this configuration, the independently driven wheels may stably support the load of the motorcycle and reduce energy consumption most effectively.

In addition, the motorcycle may have two or three independently driven wheels so as to give a maximized energy saving effect without increasing the product cost of the motorcycle.

### ADVANTAGEOUS EFFECTS

Generally, the amount of energy consumed by a motorcycle exhibits a pattern as shown in FIG. 2 with time. Namely, the amount of energy consumption increases rapidly after start-up until it reaches a predetermined driving speed. But, if the motorcycle reaches a predetermined speed and runs stably, the amount of energy consumption decreases and becomes stabilized.

A motorcycle proposed herein also exhibits an energy consumption pattern substantially similar to the above, but the amount of energy consumed by one independently driven wheel is greatly reduced than a general motorcycle as shown in FIG. 2. That is, by using at least two independently driven wheels, the amount of overall energy consumption may be decreased by about 30 to 40% when the energy consumption by all wheels is added up.

### BRIEF DESCRIPTION OF DRAWINGS

FIG. 1 is a side view showing a structure of an electric motorcycle according to one embodiment of the present invention; and

FIG. 2 is a graph illustrating the amount of consumed energy of the electric motorcycle according to one embodiment of the present invention.

### BEST MODE FOR CARRYING OUT THE INVENTION

Hereinafter, embodiments of the present invention will be described in detail with reference to the accompanying drawings.

This embodiment is explained based on an electric motorcycle, but it is not intended to limit the present invention to an electric motorcycle.

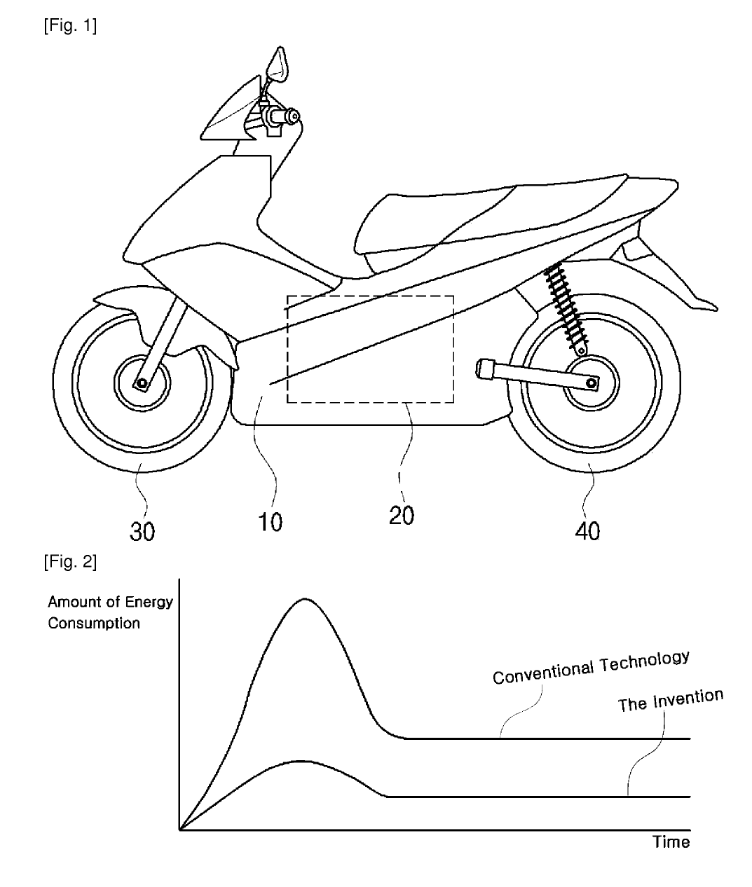

The motorcycle of this embodiment may be a multi-wheeled motorcycle, e.g., two-wheeled or three-wheeled motorcycles, as shown in FIG. 1. The motorcycle of this embodiment has a rechargeable battery 20, similarly to general electric motorcycles. The battery 20 is substantially identical to generally used batteries, so it is not explained in detail here. The battery 20 may be easily charged using 220V power generally used in houses, and a relatively cheaper late-night electricity may be used to charge the motorcycle, and then the motorcycle may be used in daytime. Also, in case there is a more excellent battery than general batteries, that battery may be used for the motorcycle of this embodiment. The motorcycle of this embodiment may exhibit an excellent energy efficiency with the same battery.

Also, the motorcycle of this embodiment is substantially identical to general motorcycles in aspects of arrangement of wheels, coupling structure of wheels to a body, steering system, shock-absorbing system and so on, so they are not explained in detail here. In case the motorcycle of this embodiment is a two-wheeled motorcycle, its two wheels are driven independently. Thus, a front wheel 30 and a rear wheel 40 are all independently driven wheels, and the front and rear wheels 30, 40 are driven using separate driving means. If the front and rear wheels 30, 40 are driven independently, power is distributed, and thus overall energy consumption may be decreased.

In addition, since the front and rear wheels 30, 40 are driven independently in this embodiment, the front and rear wheels 30, 40 may be rotated at different speeds, so a rotation speed synchronizing system for synchronizing rotation speeds of the front and rear wheels 30, 40 may be further provided.

Meanwhile, in case the motorcycle of this embodiment is a three-wheel or four-wheeled motorcycle, at least two wheels among all the wheels are driven independently. It is also possible that all the wheels are driven independently. In this case, a rotation speed synchronizing means for synchronizing rotation speeds of all the independently driven wheels may be further provided.

In addition, in the motorcycle of this embodiment, each independently driven wheel 30, 40 may be a motor built-in wheel that includes a built-in motor in a wheel. In case the independently driven wheel 30, 40 is a motor built-in wheel, a separate power transmission means needs not be provided, so unnecessary energy consumption does not occur during the power transmission process. Thus, more efficient energy reduction is allowed.

The motor built-in wheel used in this embodiment is substantially identical to general motor built-in wheels, so it is not described in detail here.

The invention has been described in detail with reference to preferred embodiments thereof. However, it will be appreciated by those skilled in the art that changes may be made in these embodiments without departing from the principles and sprit of the invention, the scope of which is defined in the accompanying claims and their equivalents.

1. A low energy consumption motorcycle, which has at least two independently driven wheels that are driven independently.

2. The low energy consumption motorcycle as claimed in claim 1, wherein the independently driven wheel is driven using a motor.

3. The low energy consumption motorcycle as claimed in claim 2, wherein the independently driven wheel is a motor built-in wheel that has a built-in motor in a wheel.

4. The low energy consumption motorcycle as claimed in claim 1, wherein at least one of the independently driven wheels is arranged at a front portion of the motorcycle, and at least one of the independently driven wheels is arranged at a rear portion of the motorcycle.

5. The low energy consumption motorcycle as claimed in claim 1, wherein the motorcycle has two or three independently driven wheels.
